(19) United States
(12) Patent Application Publication
(10) Pub. No.: US 2021/0305745 A1
(43) Pub. Date: Sep. 30, 2021

(54) ELECTRICAL CONNECTOR AND CONNECTOR PLUG SYSTEM

(71) Applicant: Lear Corporation, Southfield, MI (US)

(72) Inventors: Robert Klawinski, Remscheid (DE); Sven Vesper, Remscheid (DE); Sophie Thölen, Remscheid (DE); Michaela Weger, Remscheid (DE); Sami Mezrioui, Remscheid (DE)

(73) Assignee: Lear Corporation, Southfield, MI (US)

(21) Appl. No.: 17/186,837

(22) Filed: Feb. 26, 2021

(30) Foreign Application Priority Data
Mar. 25, 2020 (DE) 102020108278.9

(51) Int. Cl. H01R 13/432; H01R 4/02

(52) U.S. Cl. CPC H01R 13/432; H01R 4/027

(57) ABSTRACT

An electrical connector includes a base body having a contact portion and a connection portion. The base body has a plug receptacle in the contact portion and a latching arm for fastening the connector. The latching arm is formed at least partially from a first layer of material and a second layer of material. The latching arm is pivotable out of a latching position counter to a spring force at least in the direction of a release position. Thus, reliable fastening of the electrical connector is ensured with low assembly force because the first layer and the second layer are at least partially separated from each other when the latching arm is pivoted in the direction of the release position.

### BACKGROUND OF THE INVENTION

Electrical connectors and connector systems are known in the prior art in a variety of embodiments. Generic electrical connectors serve to accommodate at least one connector blade in order to establish an electrical connection. The connection portion is thereby connected to an electrical conductor such as, for example, a cable or a terminal rail.

To form a connector system, for example, a plurality of electrical connectors is fastened with their latching arms inside a terminal housing. In the terminal housing, the connectors can be contacted via their connection portions. Generic electrical connectors are known, for example, from US 2018/0351275 A1 and WO 2014/127817 A1.

However, the electrical connectors known from the prior art have the disadvantage that the electrical connectors may be damaged during assembly because the force to be applied to swivel the latching arm from its latching position in the direction of the release position is too great. Nevertheless, reliable fastening of the electrical connector within a receptacle housing is to be ensured by the latching arm.

This invention is, therefore, based on the task of providing an electrical connector and a connector system in which reliable fastening of the connector is ensured with a low mounting force.

### SUMMARY OF THE INVENTION

The invention relates to an electrical connector including at least one base body having at least one contact portion and at least one connection portion. The base body is formed from a sheet metal material. The base body has at least one plug receptacle in the contact portion that is designed, for example, to receive at least one plug blade. In order to secure the connector, for example, in a receptacle housing, the base body has at least one latching arm. At least a portion of the latching arm is formed from a first layer of sheet metal material, and at least a portion of the latching arm is formed from a second layer of sheet metal material. At least a part of the latching arm is pivotable from a latching position against a spring force at least in the direction of a release position, in particular, into at least one release position. Furthermore, the invention relates to a connector plug system.

The aforementioned task is solved in a generic electrical connector with the features in that the first layer and the second layer are at least partially separated from each other when at least part of the latching arm is pivoted in the direction of the release position. By at least partially separating the first layer and the second layer when the latching arm is pivoted toward the release position, the first layer and the second layer are deflected to different degrees, thereby reducing the assembly force when an electrical connector is inserted into a receptacle housing. The first layer and the second layer are deformed to different extents, in particular, elastically deformed.

At least one contact portion and at least one connection portion are formed on the base body of the connector. Preferably, the electrical connector extends along an imaginary axis between the contact portion and the connection portion. The connection portion is provided for making electrical contact with the electrical connector, for example, for connecting an electrical conductor, such as the strands of a cable or a rigid conductor such as, in particular, a conductor rail. The connection portion is preferably designed in such a way that a connection to an electrical conductor can be made by means of welding (in particular ultrasonic welding), soldering, or crimping. For crimping, the connection portion has, for example, at least one crimping area and, in particular, is provided with at least one groove embossing.

The base body is formed from a sheet metal material by, for example, folding a blank of a sheet metal material several times. Preferably, the contact portion and the connection portion are formed from the blank by folding and/or bending. The base body has at least one plug receptacle in the contact portion, which is preferably designed to receive at least one plug blade.

In order to secure the electrical connector in a terminal housing, the electrical connector (in particular, the plug receptacle) has at least one latching arm. The latching arm is arranged to extend outwardly away from the contact portion in the direction of the connection portion. When the electrical connector is inserted into a terminal housing, the latching arm is pivoted in the direction of the base body starting from its latching position, in which the latching arm projects outwardly, so that the latching arm latches again in its latching position after complete insertion into the terminal housing and secures the electrical connector in the terminal housing.

The latching arm has in its extension at least one first layer of a sheet metal material and at least one second layer of a sheet metal material, each of which extends over at least part of the length of the latching arm. The first layer and the second layer are preferably arranged such that they extend one above the other, as viewed in the pivot direction of the latching arm. Both the first layer and the second layer project outwardly.

The latching arm can be pivoted from its latching position, in which it extends away from the outside, against a spring force at least in the direction of a release position. In particular, the latching arm can be pivoted into a release position. The spring force of the latching arm opposing the pivoting is modified in that the first layer and the second layer of the latching arm are at least partially separated from each other when the latching arm is pivoted in the direction of the release position. The distance between the first layer and the second layer increases over at least part of their extension when the latching arm is pivoted. The separating is related to the distance between the two layers in the latching position, which increases at least partially during pivoting. The first layer and the second layer are configured to be separable during pivoting. The first layer and the second layer are not connected to each other over at least part of their extension so that they can separate from each other depending on the load.

Preferably, when the latching arm is pivoted in the direction of the release position, predominantly only the second layer of the latching arm is elastically deformed. For example, the deformation of the first layer is less than the deformation of the second layer. Preferably, the first layer remains substantially in its initial position, in particular due to the first layer being shorter than the second layer. The latching arm can be pivoted at least partially against a spring force in the direction of the release position to the extent that only the second layer actually pivots. Since during pivoting in the direction of the release position in particular mainly or only one layer, namely the second layer, is elastically deformed, the force to be applied for pivoting is reduced.

In the latching position, the first layer and the second layer abut each other, at least in certain areas, so that the first layer and the second layer support each other and latching arm has a high level of stability, in particular due to a double layer. Consequently, the invention reduces the assembly force while ensuring high stability in the latching position.

According to a first embodiment of the connector, it has been found advantageous if the connector is made by folding a blank, and if the first layer and the second layer are folded over each other from opposite end sides of the blank. Consequently, in the blank, the first layer and the second layer are arranged at opposite end sides. By folding the blank so as, for example, to receive the plug receptacle, the opposite end sides are folded over each other such that the first layer and the second layer are arranged on top of each other and form the latching arm. Preferably, the second layer is locally tapered in at least one point in its extension.

According to a further embodiment of the connector, the first layer and the second layer are formed and arranged in such a way that the resistance force of the latching arm against deformation starting from the latching position is lower for deformation in the direction of the release position than for deformation in the opposite direction. Starting from the latching position, the resistance force of the latching arm is greater when deformed away from the release position than when deformed in the direction of the release position. This is ensured by the fact that when the latching arm moves away from the release position, both layers (i.e., the first layer and the second layer) must be deformed, whereas when the latching arm swivels in the direction of the release position, mainly or only the second layer is deformed.

Moreover, according to a further embodiment of the connector, it has been found to be advantageous that the first layer and the second layer have a curvature over at least part of their extension, in particular that the first layer and the second layer have a curvature over their entire extension. Consequently, the first layer and the second layer not only protrude outwardly, but also exhibit a curvature. Preferably, the curvature is convex in the direction of the plug receptacle. For example, the curvature may be formed as a radius.

It is also provided that the first layer and the second layer have a different curvature, at least in portions. It is also provided that the first and second layers in the latching position have a clearance resulting from the different curvature, and that the first layer and the second layer separate from each other when pivoting towards the release position, namely, the distance is increased.

In another embodiment of the connector, the first layer extends over a portion of the length of the latch arm, and the second layer extends over the entire length of the latch arm. Consequently, the first layer is formed shorter than the second layer. In this way, it can be ensured that when the connector is inserted into a terminal housing, mainly or only the second layer is deformed, and in particular that the first layer remains essentially undeformed.

In particular, in order to ensure the greatest possible stability of the latching arm in the event of deformation of the latching arm in the direction away from the release position (i.e., in the event of a release attempt of the connector mounted in a terminal housing) according to a further embodiment, it is provided that the second layer has at least one projection, and that the first layer extends approximately up to the projection. The projection preferably serves to support the second layer when the second layer is pivoted in a pivoting direction away from the release position. In this case, an end edge of the first layer is supported on the projection so that, in particular from the time of support, the first layer and the second layer can only deform together or no further deformation of both layers takes place. This increases the stability of the latching arm in the latching position. Preferably, the projection is formed by embossing at least the second layer.

Alternatively, it is provided that at least one form-fitting connection is formed between the first layer and the second layer, which is designed in such a way that the form-fitting connection engages and a force transmission is possible when the latching arm is pivoted away from the release position, and that the form-fitting connection is released when at least the second layer is pivoted in the direction of the release position. For example, the form-fitting connection is designed as a toothing. In particular, the first layer and/or the second layer has at least one projection or one recess for forming the toothing. The first layer and the second layer interact positively when pivoted in a direction away from the release position, so that they can only be moved together.

According to a further embodiment of the connector, it is provided that when the latching arm is pivoted in the direction of the release position, the second layer is elastically deformed more than the first layer, in particular that when the latching arm is pivoted in the direction of the release position, only the second layer is elastically deformed. In particular, if the first layer is shorter than the second layer, different forces can act on the first layer and the second layer or the latching arm at different attachment points so that the first layer and the second layer are deformed differently. Preferably, the first layer is not deformed at all when the latching arm is pivoted in the direction of the release position, but only the second layer is elastically deformed.

In particular, in order to modify the spring force of the latching arm depending on the application of the electrical connector, it is provided according to a further embodiment that the first layer and the second layer are connected to each other, in particular by material bonding, one or more connection points. Preferably, it is provided that the first layer and the second layer are welded to each other one or more connection points. The position of the connecting point in relation to the length of the latching arm makes it possible in particular to adjust the degree of separation and, thus, the strength of the spring force which the latching arm opposes to deformation in the direction of the release position. If the connection point is oriented closer towards the free end of the latching arm, the spring force becomes greater. If, on the other hand, the connection point is oriented further away from the free end of the latching arm, the spring force becomes weaker. It is also envisaged that the first layer and the second layer are connected to each other at a plurality of connection points.

In particular, the production of the electrical connector is simplified according to a further embodiment in that the plug receptacle has at least one contact element, in particular one contact element inserted in at least one receiving slot. For example, the contact element is inserted into two receiving slots, one in each of two opposite side walls of the plug receptacle. The contact element is inserted into the receiving slot or slots and preferably welded to the base body.

For example, according to a further embodiment, it is provided that the contact element is made of a different material than the base body, in particular of a stainless steel. This prevents relaxation occurring in the contact element. Advantageously, the base body is made of copper or a copper alloy. The base body and contact element are made of electrically conductive metals. Alternatively, it is also provided that the contact element and the base body are made of an identical material, in particular that the contact element is formed from the same sheet metal material.

A further embodiment of the connector provides that the contact element has at least one contact arm. The contact arm can be deflected against a spring force, is in contact with an inserted plug blade (preferably under the action of a spring force), and establishes the electrical contact. The contact element preferably has a base plate from which the contact arm extends away at an angle. In the assembled state, the contact arm preferably extends into a free space of the plug receptacle. The contact arm is preferably oriented with its free end in the direction of the connection portion.

Advantageously, in order to increase the number of possible mating operations, according to a further embodiment it is provided that the contact arm has a coating on at least part of its surface, in particular that the coating is applied to the contact arm or at least to part of a surface of the contact arm by roll cladding or an additive manufacturing process. Preferably, it is provided that the contact element is completely coated. The coating provides the contact arm with wear protection, which increases the number of possible mating operations. For example, the coating is made of silver or a silver alloy. Direct metal laser sintering (DMLS), electron beam melting (EBM), selective laser sintering (SLS), selective laser melting (SLM), metal binder jetting, or nano particle jetting have proven to be advantageous additive manufacturing processes, for example. The use of other additive manufacturing processes for deposition is also envisaged. It is further envisaged that the connector is fully coated by means of hot-dip tinning or galvanizing.

According to a further embodiment, contacting of a plug blade that can be inserted into the plug receptacle can be improved by the plug receptacle having a protrusion opposite the contact arm. If a plug blade is inserted into the plug receptacle, it is preferably contacted between the protrusion and the contact arm. Preferably, it is provided that the protrusion has a coating on at least part of its surface. In particular, the coating is applied to the protrusion by roll cladding or by an additive manufacturing process.

Preferably, the coating is applied to the protrusion in the electrical connector blank state by, for example, roll cladding or an additive manufacturing process. The blank is then folded to form the connector, and the coating is given its final position on the protrusion or at least a partial surface of the protrusion.

Alternatively, it is proposed that the latching arm be formed in a double layer including a first layer and a second layer, and that the first layer and the second layer are superimposed in an imaginary plane in which the latch arm pivots. Further alternatively, it is proposed that the first layer and the second layer are folded over each other from opposite end sides of a blank for the connector. Further alternatively, it is provided that the first layer and the second layer are superimposed and are unconnected at their free end. These features may also provided in combination with the foregoing embodiments.

The task stated at the beginning is further solved by a connector system with at least one terminal housing and at least one electrical connector. The electrical connector is designed according to one of the embodiments described above. It is particularly advantageous if the connection plug system has a plurality of electrical connectors in the terminal housing. In this way, a connector system with a plurality of electrical contacts can be contacted.

A separate receptacle opening is provided in the housing for each connector. The receptacle opening is preferably dimensioned in such a way that only part of the latching arm is deflected when the connector is inserted into the receptacle opening, in particular only the second layer is deflected.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of an embodiment of an electrical connector in accordance with this invention.

FIG. 2 is a sectional side elevational of the electrical connector illustrated in FIG. 1 during insertion into a terminal housing.

FIG. 3 is a sectional side elevational view similar to FIG. 1 showing the electrical connector in a latching position within the terminal housing.

FIG. 4 is a perspective view of a blank that can be used to manufacture the electrical connector shown in FIGS. 1, 2, and 3.

FIG. 5 is an exploded perspective view of the electrical connector in FIGS. 1, 2, and 3 shown partially assembled.

FIG. 6 is an end elevational view of the fully assembled electrical connector shown in FIG. 1.

### DETAILED DESCRIPTION OF THE PREFERRED EMBODIMENT

Regarding the following description, it should be understood that the invention is not limited to the specific embodiments illustrated and described herein and, thus, not limited to all or several features of described feature combinations. Rather, each individual partial feature of the/each embodiment example is also of importance for the subject matter of the invention detached from all other partial features described in connection therewith for itself and also in combination with any features of another embodiment example.

FIG. 1 shows an embodiment of an electrical connector 1 in accordance with this invention. The electrical connector 1 has a base body 2. The base body 2 has at least one contact portion 3 and at least one connection portion 4. The illustrated connection portion 4 is intended for connection to an electrical conductor, in particular the strands of a cable, by means of crimping. A plug receptacle 5 is formed in the contact portion 3 that serves to receive at least one plug blade (not shown). Furthermore, the base body 2 has at least one latching arm 6 for fastening the electrical connector 1. The illustrated latching arm 6 is formed at least partially from a first layer 7 and a second layer 8 of the sheet metal material of the base body 2. The latching arm 6 can be pivoted from its latching position (shown in FIG. 1) against a spring force at least in the direction of a release position (shown in FIG. 2). As shown in FIG. 1, the illustrated latching arm 6 protrudes outwardly from the contact portion 3.

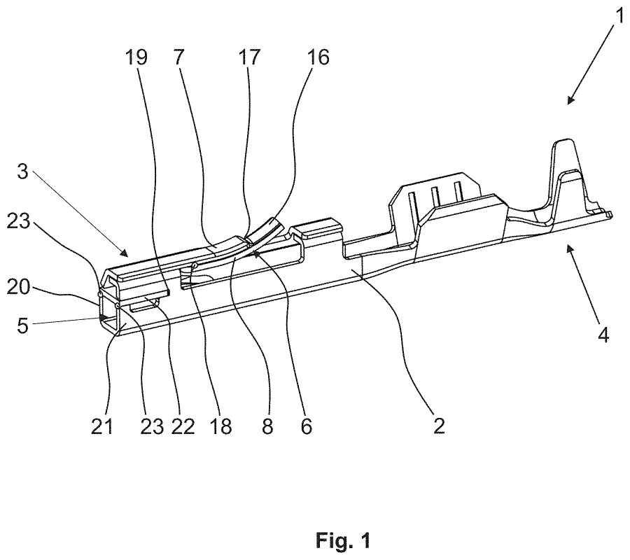

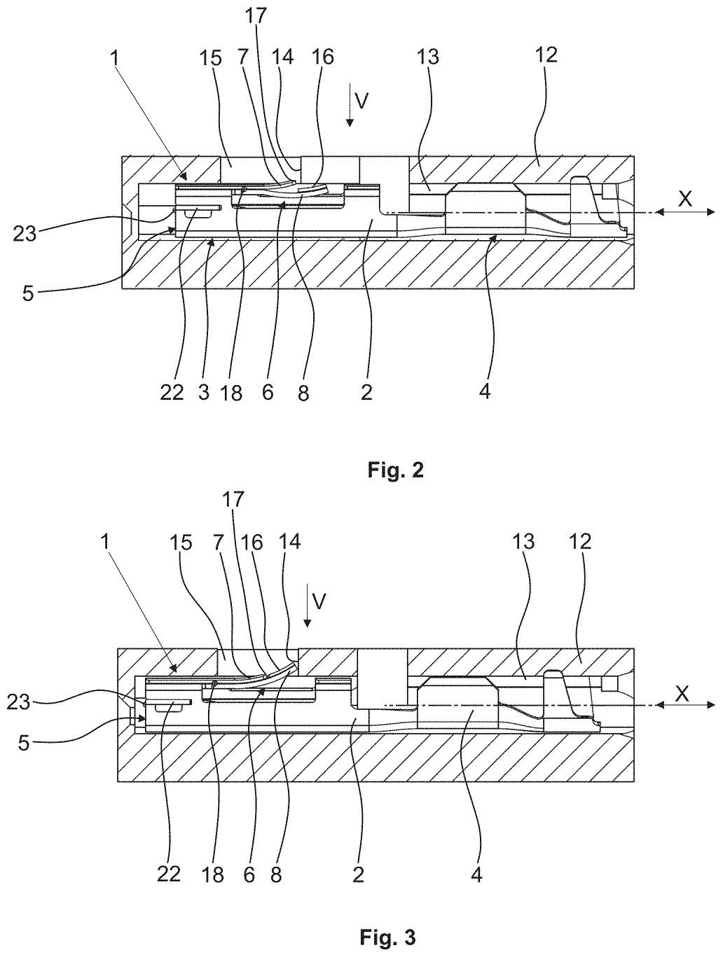

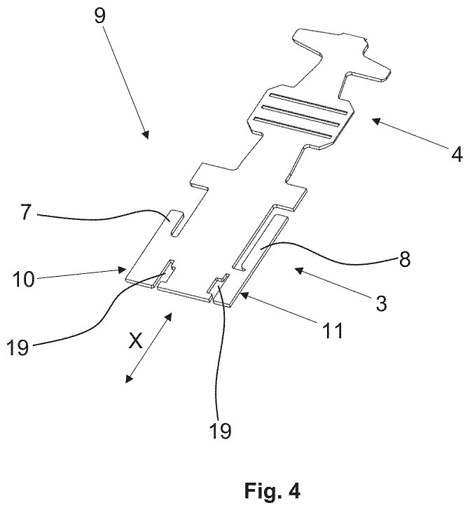

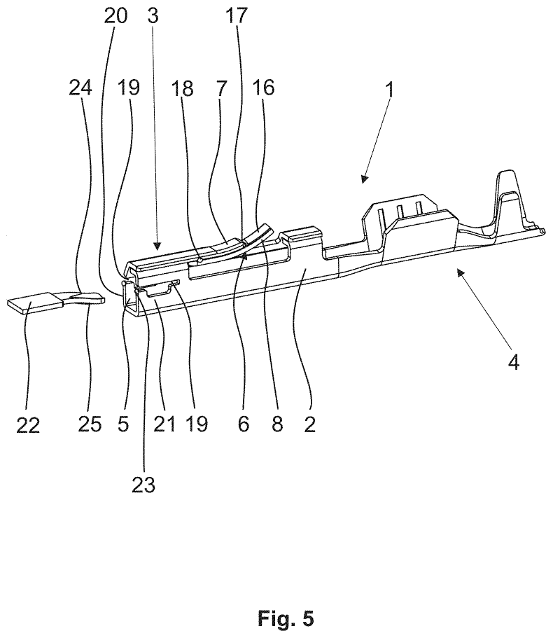

The electrical connector 1 according to FIG. 1 may be manufactured by folding a blank 9 (such as shown in FIG. 4 for example) for an electrical connector 1. According to FIG. 4, the first layer 7 may be arranged at a first end side 10 of the blank 9, and the second layer 8 may be arranged at a second end side 11 of the blank 9. During manufacture, the first and second end sides 10, 11 are folded over each other so that the first layer 7 and the second layer 8 are arranged one above the other in the area of the plug receptacle 5, as shown in FIG. 1.

FIG. 2 and FIG. 3 show an embodiment of a connector 1, in particular according to FIG. 1, in a terminal housing 12. FIG. 2 shows the connector 1 during insertion, while FIG. 3 shows the connector 1 in the latching position in the terminal housing 12. As shown in FIG. 2, at least a part of the latching arm 6 (namely, the second layer 8) is pivoted from its latching position against a spring force in the direction of a release position during insertion into a receptacle opening 13 of the terminal housing 12. In this embodiment, the first layer 7 is not pivoted during insertion. For this purpose, the receptacle opening 13 is designed in such a way that only the second layer 8 is pivoted. In the release position of the latching arm 6, the connector 1 can be inserted into the receptacle opening 13 along its longitudinal direction (the X direction according to FIG. 2). According to FIG. 2, the first layer 7 and the second layer 8 are separated from each other in that only the second layer 8 is elastically deformed.

In FIG. 3, the connector 1 is shown in a position fixed in the receptacle opening 13 of the terminal housing 12. The latching arm 6, in particular the second layer 8 of the latching arm 6, rests against a latching edge 14 of a recess 15. If an attempt were made in this position to pull the electrical connector 1 back out of the terminal housing 12 against its insertion direction (see arrow in FIG. 2), this would be prevented by interaction of the latching arm 6 with the latching edge 14.

As can be seen in particular from FIG. 2, the second layer 8 has a projection 16 arranged at its free end. In the latching position of the latching arm 6 (for example, according to FIG. 1), the first layer 7 extends up to the projection 16. According to FIG. 3, during an attempt to pull out, the first layer 7 (in particular, an end edge 17 of the first layer 7) braces itself on the projection 16 so that the first layer 7 and the second layer 8 would be jointly loaded when pivoted in a pivoting direction away from the release position. The first layer 7 thereby supports the second layer 8, increasing the force applied by the latch arm 6 and increasing the stability of the latch arm 6.

As shown in FIGS. 1, 2, and 3, the first layer 7 and the second layer 8 are connected together at a connecting point 18, such as by spot welding, for example. The connecting point 18 ensures that separation of the first layer 7 from the second layer 8 occurs at maximum up to the connecting point 18. In this way, the degree of separation (and, thus, the strength of the spring force of the latching arm 6) can be adjusted via the position of the connecting point 18. If the connecting point 18 would be shifted in the direction of the free end of the latching arm 6, the spring force would increase when pivoting in the direction of the release position.

FIG. 4 shows the blank 9 for the electrical connector 1 according, for example, to FIGS. 1, 2, and 3. The blank 9 is folded essentially around an axis X to produce the electrical connector 1. In this process, the opposite end sides 10, 11 are moved towards each other, and the first layer 7 is folded over the second layer 8. The first layer 7 is formed shorter than the second layer 8.

FIGS. 1 through 3 show the electrical connector 1 in a fully assembled state. FIG. 5 shows the electrical connector 1 in a partially assembled state. According to FIGS. 1 through 3 and 5, a receiving slot 19 is formed respectively in both a first side wall 20 and an opposite second side wall 21 in the area of the plug receptacle 5. A contact element 22 is inserted into the receiving slots 19 and is connected to the base body 2. The illustrated contact element 22 is connected to the side walls 20, 21 by a spot weld 23 in a material fitting manner. The contact element 22 bounds the plug receptacle 5 on one side. The contact element 22 has a contact arm 24, the free end of which extends in the direction of the connection portion 4. The contact arm 24 has at least one coating 25 that is oriented in the direction of the plug receptacle 5 and, in the case of an inserted plug blade (not shown), is connected to the plug blade.

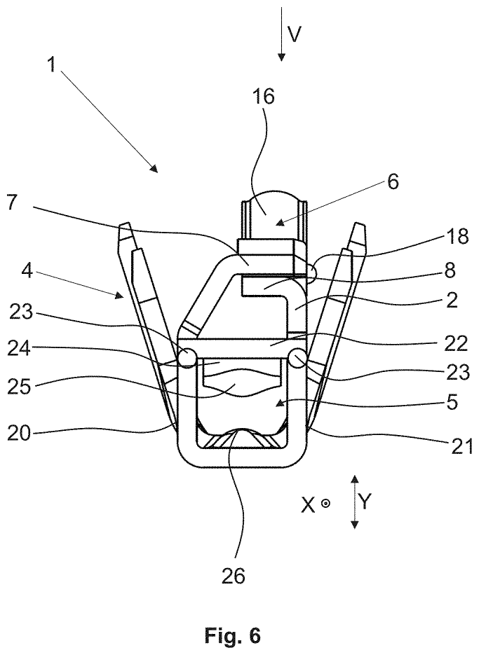

FIG. 6 is an end elevational view of the fully assembled electrical connector shown in FIG. 1. It can be clearly seen therein how the contact arm 24 extends into the plug receptacle 5. Furthermore, it can be seen that the base body 2 has a protrusion 26 disposed in the connector receptacle 5 opposite the contact arm 24. When inserted within the plug receptacle, the plug blade (not shown) is clamped between the protrusion 26 and the contact arm 24. In this embodiment, the plug receptacle 5 has a substantially square cross-section. The latching arm 6 extends outwardly. The connector portion 4 is still uncrimped. The first layer 7 and the second layer 8 are arranged one above the other, as viewed in the pivoting direction V of the latching arm 6 or in a Y axis arranged orthogonally to the X axis.

The invention is not limited to the embodiment shown and described, but also includes all embodiments having the same effect in the sense of the invention. It is expressly emphasized that the embodiments are not limited to all features in combination. Rather, each individual sub-feature may also have inventive significance in isolation from all other sub-features. Furthermore, the invention has not yet been limited to the combination of features described and illustrated herein, but can also be defined by any other combination of certain features of all the individual features disclosed as a whole. This means that, in principle, virtually any individual feature can be omitted or replaced by at least one individual feature disclosed elsewhere in the application.

What is claimed is:

1. An electrical connector comprising:
at least one base body with at least one contact portion and at least one connection portion, wherein the base body is formed from a sheet metal material, wherein the base body has at least one plug receptacle in the contact portion, wherein the base body has at least one latching arm for fastening the connector, wherein the latching arm is formed at least partially from a first layer of the sheet metal material and a second layer of the sheet metal material, and wherein the latching arm can be pivoted out of a latching position against a spring force at least in the direction of a release position, characterized in that
the first layer and the second layer are at least partially separated from each other when the latching arm is pivoted in the direction of the release position.

2. The electrical connector according to claim 1, characterized in that the connector is made by folding a blank, and that the first layer and the second layer are folded over each other from opposite end sides of the blank.

3. The electrical connector according to claim 1, characterized in that the first layer and the second layer are formed and arranged in such a way that a resistance force of the latching arm starting from the latching position against a deformation in the direction of the release position is lower than against a deformation in the opposite direction.

4. The electrical connector according to claim 1, characterized in that the first layer and the second layer have a curvature over at least part of their extension, in particular that the first layer and the second layer have a curvature over their entire extension.

5. The electrical connector according to claim 1, characterized in that the first layer extends over part of the length of the latching arm, and in that the second layer extends over the entire length of the latching arm.

6. The electrical connector according to claim 1, characterized in that the second layer has at least one projection, and that the first layer extends approximately up to the projection on the second layer, in particular in that the projection is formed by embossing.

7. The electrical connector according to claim 6, characterized in that the projection of the second layer is braced against the first layer, in particular an end edge of the first layer, when the second layer is pivoted away from the release position.

8. The electrical connector according to claim 1, characterized in that when the latching arm is pivoted in the direction of the release position, the second layer is elastically deformed to a greater extent than the first layer, in particular that when the latching arm is pivoted in the direction of the release position, only the second layer is elastically deformed.

9. The electrical connector according to claim 1, characterized in that the first layer and the second layer are connected to one another, in particular by a material bond, at least one connecting point, in particular in that the degree of separation and thus the degree of resistance of the latching arm is set with the position of the connecting point in relation to the length of the latching arm.

10. The electrical connector according to claim 1, characterized in that the plug receptacle has at least one contact element, in particular inserted into at least one receiving slot, preferably in that the contact element is welded to the base body.

11. The electrical connector according to claim 10, characterized in that the contact element has at least one contact arm, and that the contact arm is deflectable against a spring force.

12. The electrical connector according to claim 11, characterized in that the contact arm has a coating on at least part of its surface, in particular that the coating is applied by roll plating, galvanizing or an additive manufacturing process, preferably that the contact element is completely coated.

13. The electrical connector according to claim 12, characterized in that the plug receptacle has a protrusion opposite the contact arm, in particular that the protrusion has a coating on at least part of its surface, preferably that the coating is applied by roll plating, galvanizing or an additive manufacturing process.

14. The electrical connector according to claim 10, characterized in that the contact element is made of a different material than the base body, in particular of a stainless steel.

15. A connector plug system with at least one receptacle housing and at least one electrical connector, in particular a plurality of electrical connectors, wherein the electrical connector is at least partially inserted into the receptacle housing, characterized in that the electrical connector is formed according to claim 1.
